(19) United States
(12) Patent Application Publication
(10) Pub. No.: US 2024/0047095 A1
(43) Pub. Date: Feb. 8, 2024

(54) BUS BAR

(71) Applicant: Peter Gazerro, (US)

(72) Inventor: Peter Gazerro, (US)

(21) Appl. No.: 17/879,191

(22) Filed: Aug. 2, 2022

(51) Int. Cl. H01B 1/02; H01B 5/02

(52) U.S. Cl. CPC H01B 1/02; H01B 5/02

(57) ABSTRACT

An electrical grounding bus bar has an aluminum plate main body having a thickness between 80 mils and half-inch. The aluminum plate main body has at least five tap holes. Each tap hole is threaded to a 10-32 standard. At least one main opening larger than each of the at least five tap holes. The aluminum plate main body can be made in a rectangular form cut from a plate of aluminum. The aluminum plate main body can be made in a circular form cut from a plate of aluminum. A tap hole thread dimension is preferable 32 threads per inch with a diameter of 0.1875″.

### DISCUSSION OF RELATED ART

A bus bar is a piece of conductive material such as metal that conducts electricity. A grounding bus bar is a busbar used for connecting grounds. The bus bar has a variety of different configurations. For example in U.S. Pat. No. 9,490,465 to inventor Jan, issued Nov. 8, 2016, the disclosure of which is incorporated herein by reference, a Z-Shaped Bus Bar for a Battery Pack provides interconnection between batteries. In U.S. Pat. No. 9,893,331 issued Feb. 13, 2018, by inventor Hongo, issued Feb. 13, 2018 entitled Battery Adhesion Fixation Structure, the bus bar has openings for interconnection of electrodes and terminals. In U.S. Pat. No. 9,929,391 to Nakamura entitled Bus Bar Module With Insulating Laminate Portion, issued Mar. 27, 2018, the laminate portion has an insulating material that includes thermoplastic elastomer or rubber and connects different terminals of respective batteries in a battery group.

### BRIEF DESCRIPTION OF THE DRAWINGS

FIG. 1 is a top view of a rectangular electrical grounding bus bar.

FIG. 2 is a perspective view of the rectangular electrical grounding bus bar.

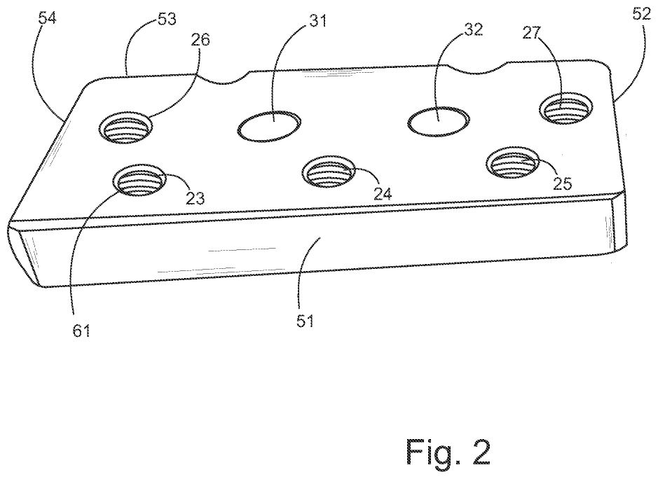

FIG. 3 is a top view of a circular electrical grounding bus bar.

FIG. 4 is a perspective view of the secular electrical grounding bus bar.

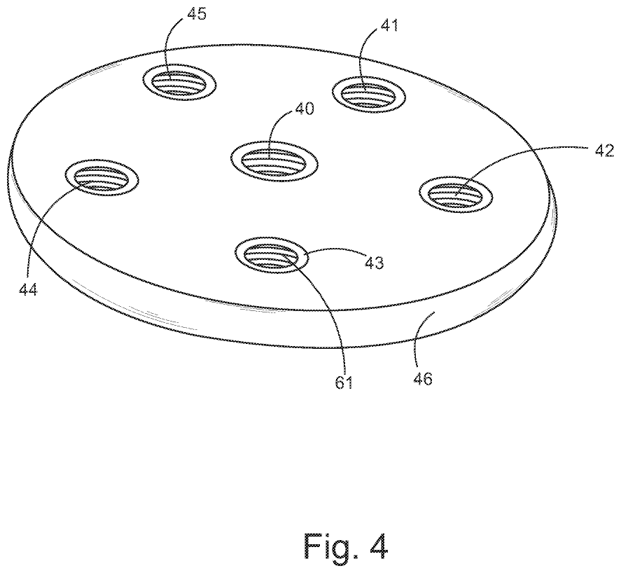

The call out list of elements can be a useful guide in referencing the element numbers of the figures.
21 first row
22 second row
23 first tap hole
24 second tap hole
25 third tap hole
26 fourth tap hole
27 fifth tap hole
31 first main opening
32 second main opening
40 central ground tap hole
41 first peripheral tap hole
42 second peripheral tap hole
43 third peripheral tap hole
44 fourth peripheral tap hole
45 fifth peripheral tap hole
46 circumferential edge
51 first long edge
52 first short edge
53 second long edge
54 second short edge
61 thread
100 tap hole thread dimension
101 rectangular width
102 rectangular links
103 main tap hole thread dimension
104 first row distance from edge
204 second row distance from edge
105 disc main body diameter
106 central tap hole thread dimension
107 model number indicator
108 model number indicator
109 grounding indicator
202 rectangular body

### DETAILED DESCRIPTION OF THE PREFERRED EMBODIMENT

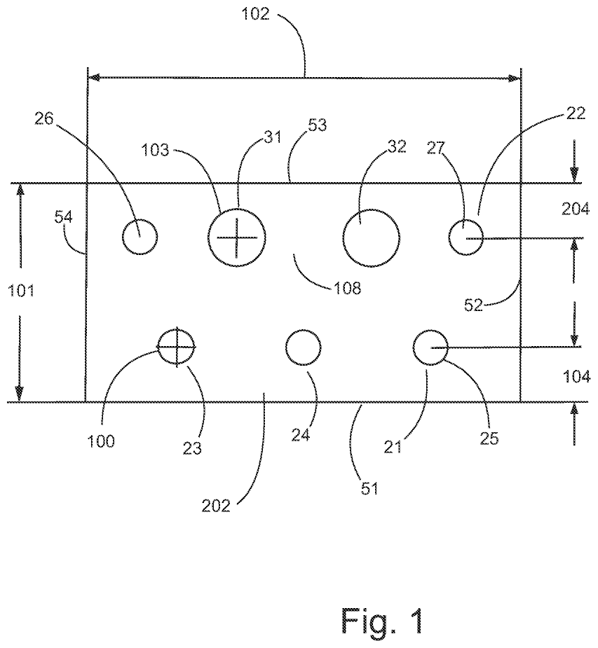

Electrical grounding bus bars of the present invention are preferably made in a rectangular form cut from a plate of aluminum. As seen in FIG. 1, the electrical grounding bus bar has a first long edge 51, a second long edge 53 that are parallel and a first short edge 52 and a second short edge 54 that are parallel. The electrical grounding bus bar has a first row 21 of openings, and a second row 22 of openings.

The first row has a first tap hole 23, a second tap hole 24, a third tap hole 25 on the first row 21. The first row holes have a visible diameter of 0.16″ and have a tap hole thread dimension 100. The tap hole thread dimension 100 is preferably 10-32 which means 32 threads per inch with a diameter of 0.1875″ which is 3/16ths of an inch or 4.76 mm. Since 0.1875″ minus 0.16″ is 0.0274″, the threads are approximately 0.0274″ deep. The plate thickness is between 80 mils and ¼″. The busbar can have a mechanical or electrically insulative layer such as a felt backing on an underside of the busbar. The second row includes a fourth tap hole 26 and a fifth tap hole 27.

The first through fifth tap holes are tapped to 10-32. A first main opening 31 and a second main opening 32 at 0.26″ diameter are located between the fourth tap hole and the fifth tap hole. The rectangular body 202 has a rectangular width 101 preferably of 1″ and a rectangular length 102 preferably of 2″. The first row distance from edge 104 dimension is preferably 0.25″, and the second row distance from edge 204 dimension is preferably 0.25″. The dimensions given herein are approximate. Reasonable tolerances or deviations may arise during manufacturing. The main tap hole thread dimension 103 is preferably 0.26″. The upper surface may have a model number indicator 108.

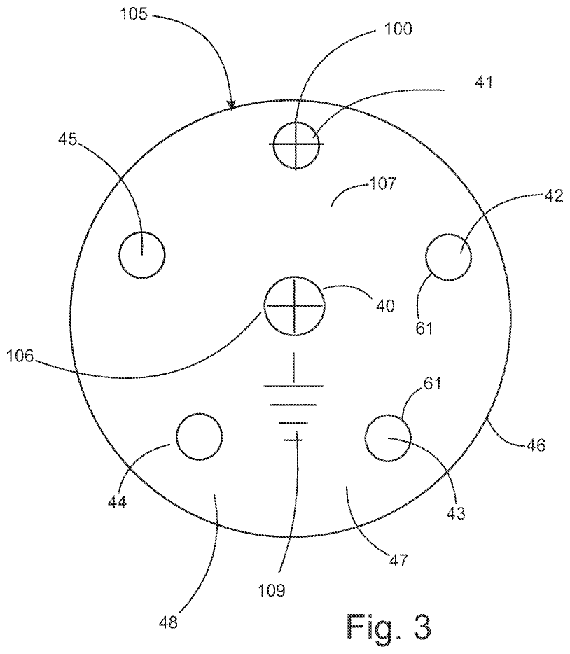

As seen in FIG. 3, the electrical grounding bus bar can be formed as a circular aluminum plate having a disc main body diameter 105 of preferably 1.5 inches. The circular aluminum plate has a central ground tap hole 40 at ¼-20 thread means a thread having a major diameter of 0.25″ and 20 threads per inch. The circular aluminum plate has five tap holes circumscribing the centrally located ground tap hole 40. A first peripheral tap hole 41, a second peripheral tap hole 42, a third peripheral tap hole 43, a fourth peripheral tap hole 44, and a fifth peripheral tap hole 45 circumscribing the centrally located ground tap hole 40. Each of the openings preferably are threaded with a thread 61. The circumferential edge 46 as a circular profile to bound the disc main body 47. Preferably, the disc main body is cut from an aluminum plate. A variety of different industrial processes can generate aluminum plate circular cutoffs as a byproduct and these circular cutoffs can be further machined to become the circular electrical grounding bus bars by securing the workpiece at the central ground tap hole 40. The peripheral tap holes are also threaded to 10-32. The busbar can have a mechanical or electrically insulative layer such as a felt backing on an underside of the busbar. The upper surface may have a model number indicator 107. The grounding indicator 109 can be a grounding symbol etched on the top surface of the circular shaped disc. The tap hole thread dimension 100 is preferably 10-32. The central tap hole thread dimension 106 is preferably ¼-20 which is a quarter inch major diameter and twenty threads per inch.

In use, the bus bars can be anchored to concrete or to other electrical structures. The mounting can be at the first main opening 31, the second main opening 32 for the rectangular embodiment, and for the circular embodiment the mounting can be at the central ground tap hole 40 which mechanically and electrically connects the busbar to ground.

1. An electrical grounding bus bar comprising:
a. an aluminum plate main body having a thickness between 80 mils and half-inch;
b. at least five tap holes, wherein each tap hole is threaded to a 10-32 standard; and
c. at least one main opening larger than each of the at least five tap holes.

2. The electrical grounding bus bar of claim 1, wherein the aluminum plate main body is made in a rectangular form cut from a plate of aluminum.

3. The electrical grounding bus bar of claim 2, wherein the electrical grounding bus bar has a first long edge, a second long edge that are parallel and a first short edge and a second short edge that are parallel,

4. The electrical grounding busbar of claim 3, wherein the at least five tap holes are arranged in two rows, namely a first row of openings, and a second row of openings.

5. The electrical grounding busbar of claim 4, wherein the first row has a first tap hole, a second tap hole, a third tap hole on the first row, wherein the second row includes a fourth tap hole and a fifth tap hole.

6. The electrical grounding busbar of claim 4, wherein the first row holes have a visible diameter of 0.16″ and have a tap hole thread dimension of 32 threads per inch with a diameter of 0.1875″.

7. The electrical grounding busbar of claim 4, further including an electrically insulative layer mounted to an underside of the busbar.

8. The electrical grounding busbar of claim 4, wherein the rectangular body has a rectangular width of 1″ and a rectangular length of 2″, wherein the first row distance from an edge dimension is 0.25″, and a second row distance from an edge dimension is 0.25″, wherein the main tap hole thread dimension is 0.26″.

9. The electrical grounding busbar of claim 1, wherein the aluminum plate main body is made in a circular form cut from a plate of aluminum.

10. The electrical grounding busbar of claim 1, wherein the electrical grounding bus bar is formed as a circular aluminum plate.

11. The electrical grounding busbar of claim 10, a circular aluminum plate wherein the disc main body has a diameter of 1.5 inches.

12. The electrical grounding busbar of claim 10, wherein the circular aluminum plate has a central ground tap hole with having a major diameter of 0.25″ and 20 threads per inch.

13. The electrical grounding busbar of claim 10, wherein the circular aluminum plate has five tap holes circumscribing a centrally located ground tap hole, wherein the five tap holes include a first peripheral tap hole, a second peripheral tap hole, a third peripheral tap hole, a fourth peripheral tap hole, and a fifth peripheral tap hole, wherein each of the five tap holes are threaded.
